(19) United States
(12) Patent Application Publication
(10) Pub. No.: US 2014/0136525 A1
(43) Pub. Date: May 15, 2014

(54) UNIQUE IDENTIFICATION OF USERS ACROSS MULTIPLE SOCIAL AND COMPUTER NETWORKS

(71) Applicants: Oudi Antebi, Los Altos Hills, CA (US); Sagi Eliyahu, Gesher Aziv (IL); Shalom Shaltiel, Netanya (IL); Roy Antebi, Ganey Tikva (IL)

(72) Inventors: Oudi Antebi, Los Altos Hills, CA (US); Sagi Eliyahu, Gesher Aziv (IL); Shalom Shaltiel, Netanya (IL); Roy Antebi, Ganey Tikva (IL)

(21) Appl. No.: 13/673,914

(22) Filed: Nov. 9, 2012

(51) Int. Cl. G06F 17/30

(52) U.S. Cl. CPC G06F 17/30386
USPC 707/723; 707/758

(57) ABSTRACT

A method and a device are disclosed including a Username Software Component (USC) configured to provide a connection between a communication software application, social networking sites, and a database to allow search, retrieval, and verification of various usernames associated with a single user and uniquely identifying the single user. The database stores the various usernames for future use. When a local user receives a message from a remote user, various usernames potentially associated with the remote user are retrieved by USC. The local user validates some of the usernames to indicate that they represent the same remote user. Usernames may also be validated by weighted functions applied to user votes. Such validated usernames may be stored in the database for future use by all users to uniquely identify the same remote user. The USC may be implemented as a plug-in component or as a built-in software application functionality.

### TECHNICAL FIELD

This application relates generally to social networking. More specifically, this application relates to retrieval of context-based information related to a user uniquely identified across multiple social and computer networks and saving the unique identification information in a database for future access.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example electronic mail (email) software application interface usable with the computing device of FIG. 2 and configured to allow unique identification of a remote user across multiple social networks;

FIG. 4 shows the example email software application interface of FIG. 3 further providing a user-validation interface for verifying the identity of the remote user;

FIGS. 5A and 5B show example database records configured to store information associated with a remote user;

FIG. 6 shows an example email software application interface configured to allow delivery of unique identification of a remote user previously stored in a database; and

FIG. 7 shows an example weighted voting process by multiple remote users to establish a unique identity for another user.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular software environments such as electronic mail (email) applications, it will be appreciated that the disclosure may be used in other software environments such as instant messaging, social network chat rooms, teleconferencing applications such as Skype®, and the like.

Briefly described, a device and a method are disclosed including a Username Software Component (USC) configured to provide a connection between a communication software application, such as an email application like Microsoft's Outlook®, and social networking sites Facebook®; other online facilities associated with users such as work and personal email accounts; and a database to allow automatic or manual search, retrieval, and verification of various different usernames associated with a single user from the social networking sites and uniquely identifying the single user with one selected unique username. The database is configured to store the various usernames and the unique username for future use. In various embodiments, when a local user receives a message from a remote user, various usernames potentially associated with the remote user are retrieved using the USC and presented to the local user. The local user may verify or validate one or more of the various usernames to indicate that the validated usernames indeed represent the same remote user. Usernames may also be validated by weighting functions applied to votes from multiple other users. Such validated usernames may be stored in the database for future use by the local user and by other users to uniquely identify the same remote user. In various embodiments, the USC is in the form of a plug-in component, while in other embodiments, it is implemented as a built-in software application functionality.

With the ubiquity of computing devices such as laptop computers, computing pads and tablets, and powerful smartphones, among others, and widely available high speed computer networks, communication between large numbers of users is easier than ever. However, the hidden cost of this ease of communication is confusion and time spent sorting through multiple similar usernames which may or may not be associated with the same user. Often, a single user may have multiple work email names and personal email accounts for each of several different services such as Yahoo.com, gmail.com, hotmail.com, and the like. The single user may also have other usernames associated with various social networks.

Many of these usernames representing the same user may be similar but not the same. Additionally, usernames associated with different users may be similar creating the illusion that they belong to the same user, while they actually belong to different users. For example, a local user may receive an email from a remote user having a username. The local user may not know the real identity of the remote user based on his username or may mistakenly believe the message is from a different user. And this scenario may be repeated many times for many remote and local users. Therefore, unique identification of a user across multiple organizations, service providers, and social networks is desirable for consistency of communications and preservation of message privacy and confidentiality, lest messages are mistakenly sent to the wrong users.

### Illustrative Operating Environment

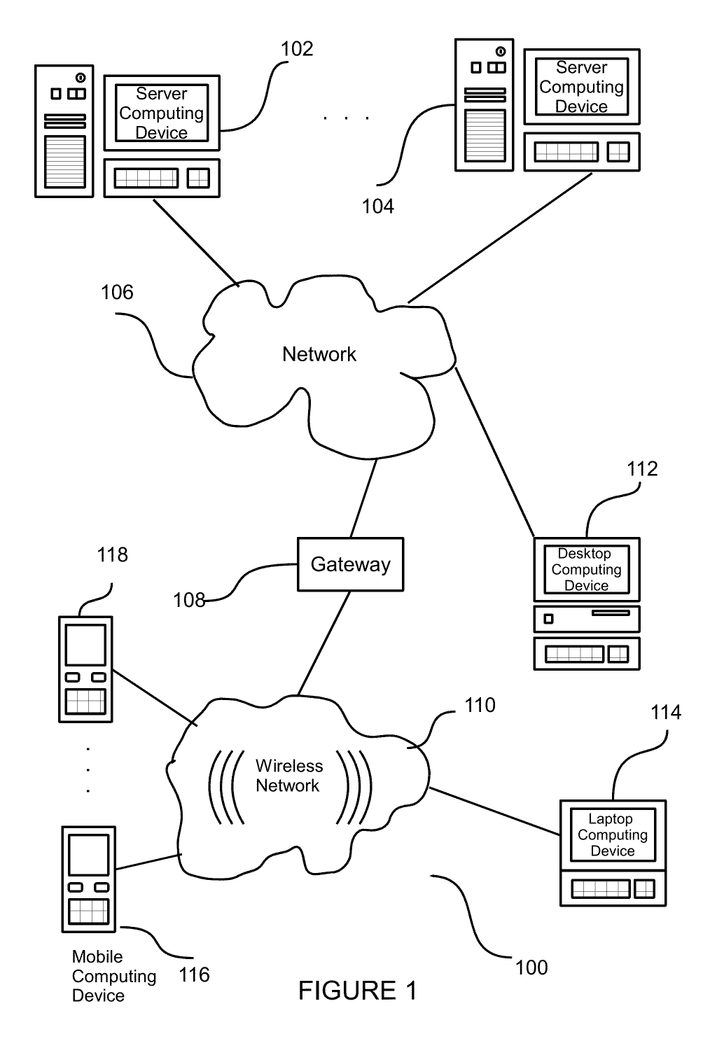

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

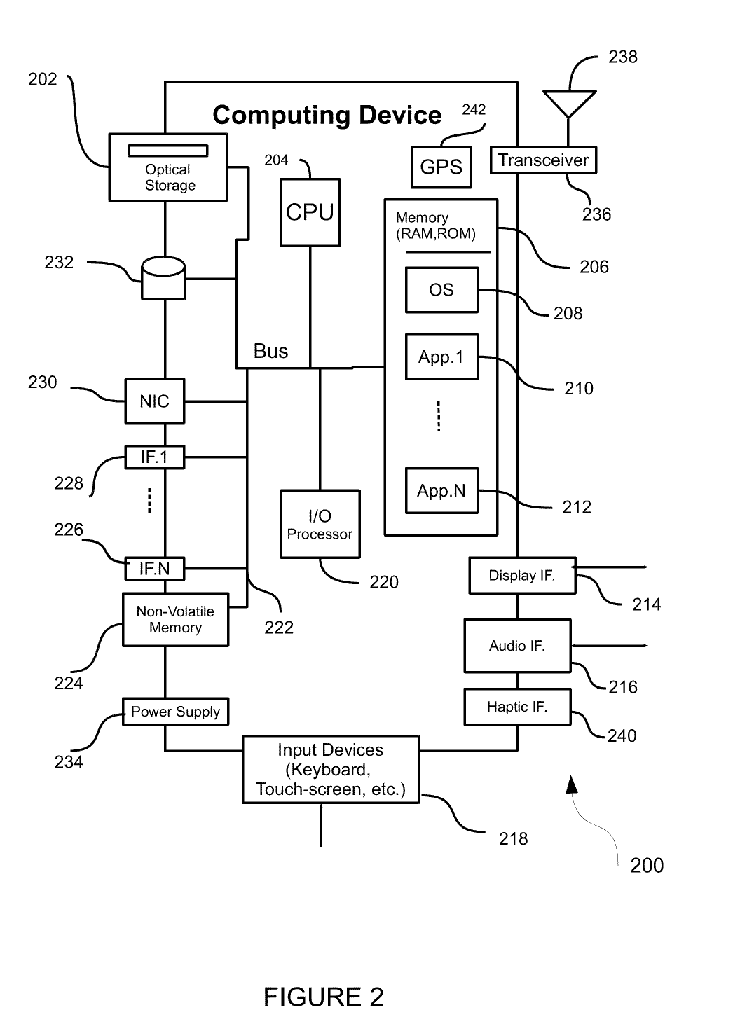

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G), and any future generation radio access technologoies for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client communication operating system such as Windows Mobile™, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

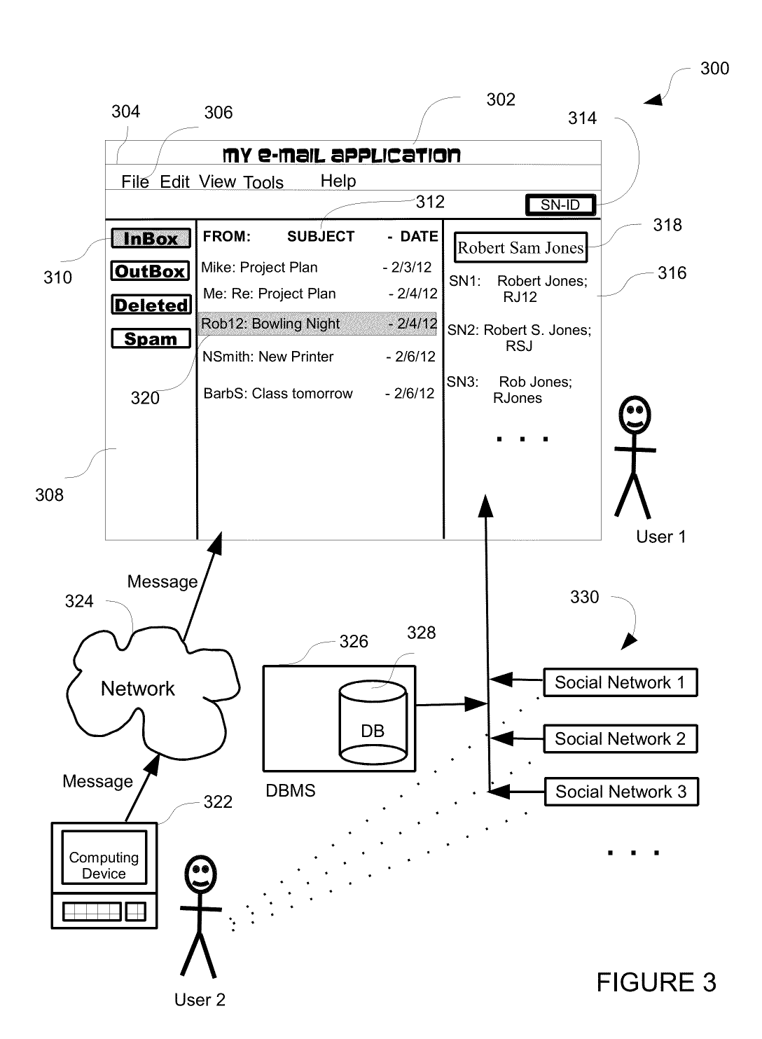

FIG. 3 shows an example electronic mail (email) software application interface usable with the computing device of FIG. 2 and configured to allow unique identification of a remote user across multiple social networks. In various embodiments, communication environment 300 used by a local user, such as user 1, may include email application 302 having menu bar 304 with menu items 306, message group pane 308 including message groups 310, message display area 312, Username Software Component (USC) user interface 314, and user identification display area 316 for displaying the real identity 318 of a remote user. A remote user, such as user 2, may send a message from computing device 322 through network 324 to user 1. Various usernames potentially associated with user 2 may be retrieved by USC user interface 314 from various social networks 330 and Data Base Management System (DBMS) 326 having Data Base (DB) storage 328 for display to user 1.

In various embodiments, communication environment 300 may include email application 302 such as Microsoft's Outlook and Outlook Express; Thunderbird; Pegasus; eM client; web-based email programs such as gmail, yahoo mail, hotmail; and the like, configured to provide messaging services between a remote user and a local user. Messaging services may include message composition, transmission, storage, search, thread management, calendar management, and the like. In such an environment, user 1 may receive emails, or other types of electronic messages, from many different people with different email names or addresses, which may be similar, but not identical, creating difficulty in positively identifying the sender. For example, a receiver may have difficulty distinguishing sender John@gmail.com from John@yahoo.com. Furthermore, the same sender, for example user 2, may send emails from different accounts, each account having a different email name or identifier, making it difficult for the receiver, for example user 1, to know that the email or message is from the same sender. Accordingly, a message receiver may make two kinds of errors in identifying the sender: false positives and false negatives. False positive type of errors are those which mistakenly identify a non-sender as a sender, while false negative type of errors are those which mistakenly identify a sender as a non-sender.

In a messaging context, these errors are made usually based on the message sender's identification, such as an email name or address. For example, the sender email address “JS12@gmail.com” may be assumed by the message receiver to be from sender Jim Smith, while it could also be from sender Joan Simons. These errors are generally significant because in replying to the email or providing additional information to the sender the receiver may reply with unsuitable messages intended for a sender other than the wrongly identified senders/recipients. Thus, information may be disclosed to the wrong person due to misidentification of the sender. In contrast, proper identification allows obtaining further supplemental information about the sender and his profile from other sources, as further detailed below.

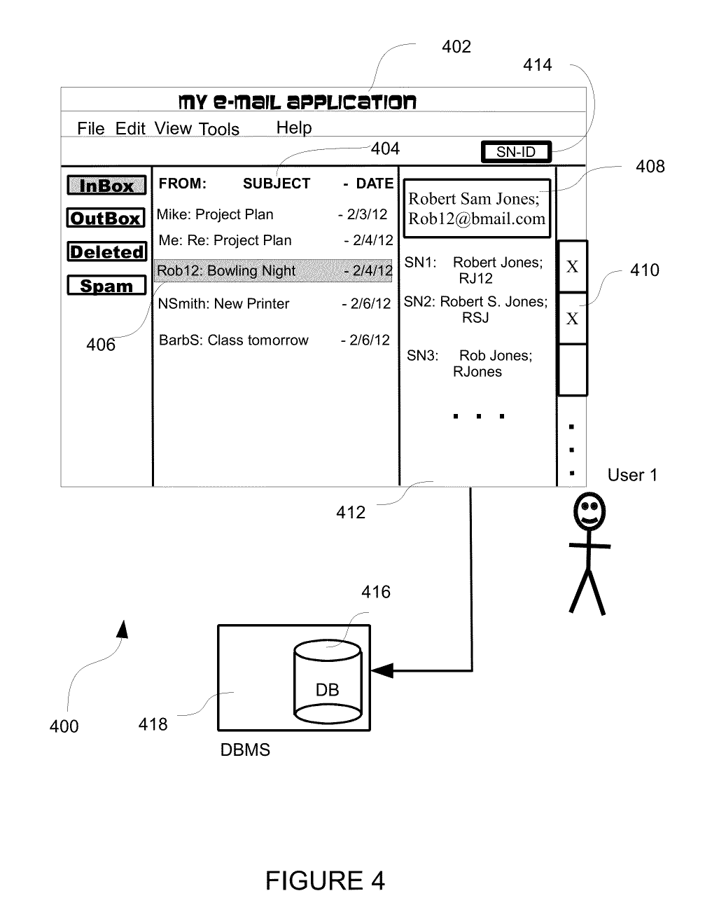

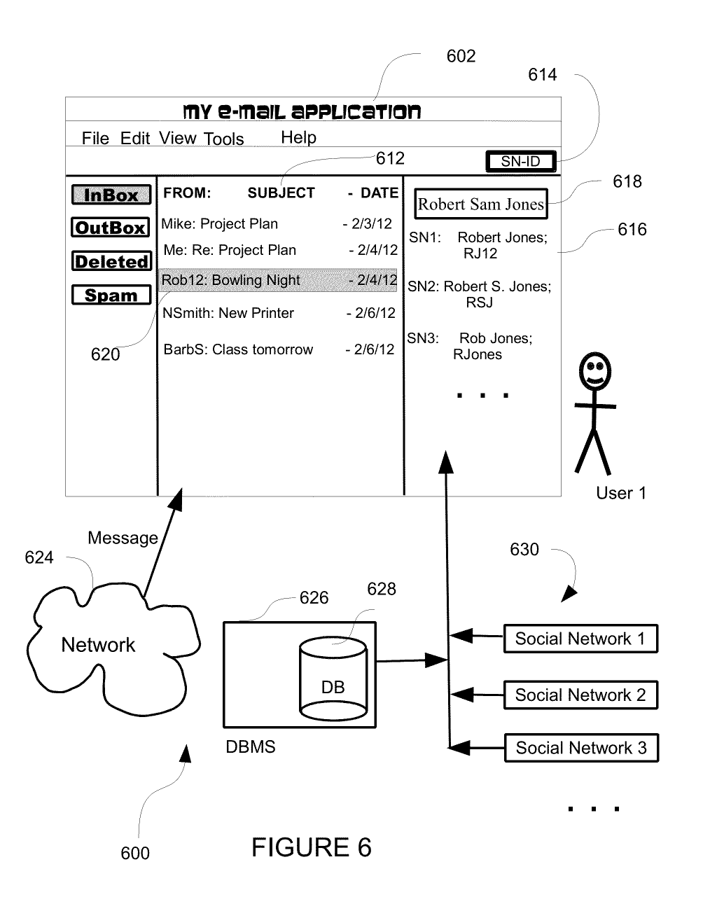

In various embodiments, recipient user 1 of message 320 may request, using user interface 314, the search for and retrieval of other identifications potentially associated with message sender user 2 from other sources, such as social networks 330. In other embodiments, the USC may be set up through menus or other application interfaces to automatically search for and retrieve any such potential sender identifications from other sources for presentation to the receiver in user identification area 316. The search for other usernames of the sender may be based on username associated with the received message, other existing usernames known to belong to the sender, sender's real full name, sender's contact information, and the like. Recipient user 1 may then use this information in correctly communicating back with the sender user 2. Database 328 may be used to store some of this information for later use, as further described below with respect to FIGS. 4 and 6.

In various embodiments, USC associated with user interface 314 may be provided as a software plug-in, configured to provide a data connection between the communication environment or application and other information sources such as social networks 330. In other embodiments, the USC may be embedded into the source code of the communication application. The USC generally has one or more predefined software interfaces which are configured to communicate various data and information between the USC and the host application (for example, email application). In still other embodiments, the USC may be implemented as a stand-alone application configured to take as input an email address or other identifying information, such as name and company information, and the like, and fetch and display other relevant information from other data sources about the input identifying information.

In various embodiments, a plug-in component may appear as a button, a toolbar, a new menu, or other common user interface components integrated with the email application. The email function may be provided as a stand-alone application, a browser based utility, a web service, as part of an integrated office suite, and the like. The plug-in component may be configured to be deployed in these various aforementioned embodiments, such as the browser or the integrated office suite. Those skilled in the art will appreciate that the plug-in component may be implemented as one or more modules, each module providing different functionalities for the plug-in component. Those skilled in the relevant arts will further appreciate that plug-in or add-in components are generally software components that run within another host program to add various capabilities, such as playing video clip players, encrypting content, messaging, and the like, within the host application originally lacking such capabilities. Plug-in components are useful at least because they may be deployed by third parties onto existing host applications after the release of such applications by their manufacturers. Plug-ins are usually installed by users after installation of the host application. A host application may generally provide a service interface (or API—Application Programming Interface) for use by plug-in components to register themselves and exchange data with the host application. Similarly, plug-ins are often installed and used in browsers to provide additional functionality in the browser's environment. Plug-ins may be implemented using DLLs (Dynamic Link Library) which are components that may be dynamically added to a running program and provide various callable functions and capabilities.

In various embodiments, the USC may include separate modules for performing different functions. For example, the USC may have a search module for searching for new usernames associated with a sender, a display module for presenting the usernames found to a receiver, a validation module for to validate the found usernames by obtaining and processing validation information from the receiver or other users, a network module for communicating with social networks and other external sources, and a database interface module for data transmission to and from the database, among other modules. Those skilled in the art will appreciate that the different USC modules may be combined into one or more modules as needed.

FIG. 4 shows the example email software application interface of FIG. 3 further providing a user-validation interface for verifying the identity of the remote user. In various embodiments, communication environment 400 used by local user, user 1, includes a messaging application, such as email application 402 includes message area 404 for displaying messages 406, user identification display area 412, for showing the real identity 408 of sender and having identity validation interface 410. USC user interface 414 may be used to retrieve other usernames used by a message sender, as described above with respect to FIG. 3. DBMS 418 including database storage 416 is coupled with the messaging application for storage of user identity information.

In various embodiments, once user 1 receives message 406 from a particular sender, the USC retrieves, on user command or automatically, other usernames associated with the particular sender, from various sources such as social networks or other email accounts and display them to user 1 in user identity display area 412. User 1 can verify and/or validate the other usernames as belonging to the particular sender. User 1 may generally validate such usernames based on his personal knowledge of such usernames and the particular sender. Once a particular username is validated as belonging to the particular sender, the particular username is added to a record associated with the particular sender in the database storage unit.

In various embodiments, DBMS 418 and/or database storage 416 may be local with respect to user 1 or may be centrally located for access by user 1 as well as by other users. The particular sender's real identity is also recorded in the database and is associated with other validated usernames for the particular sender. In various embodiments, the real identity of the particular user may be based on a full name, a particular email address or username, a GUID (Globally Unique ID), a combination thereof, and the like.

In various embodiments, identity validation interface 410 may be implemented using different techniques. For example, a radio button, a dropdown list, a data entry field, an active or hot link, and the like may be used as the user interface for validation. The database may be updated with new validated usernames and identifications on user validation of the ID, periodically, on user command, on other predefined events, and the like.

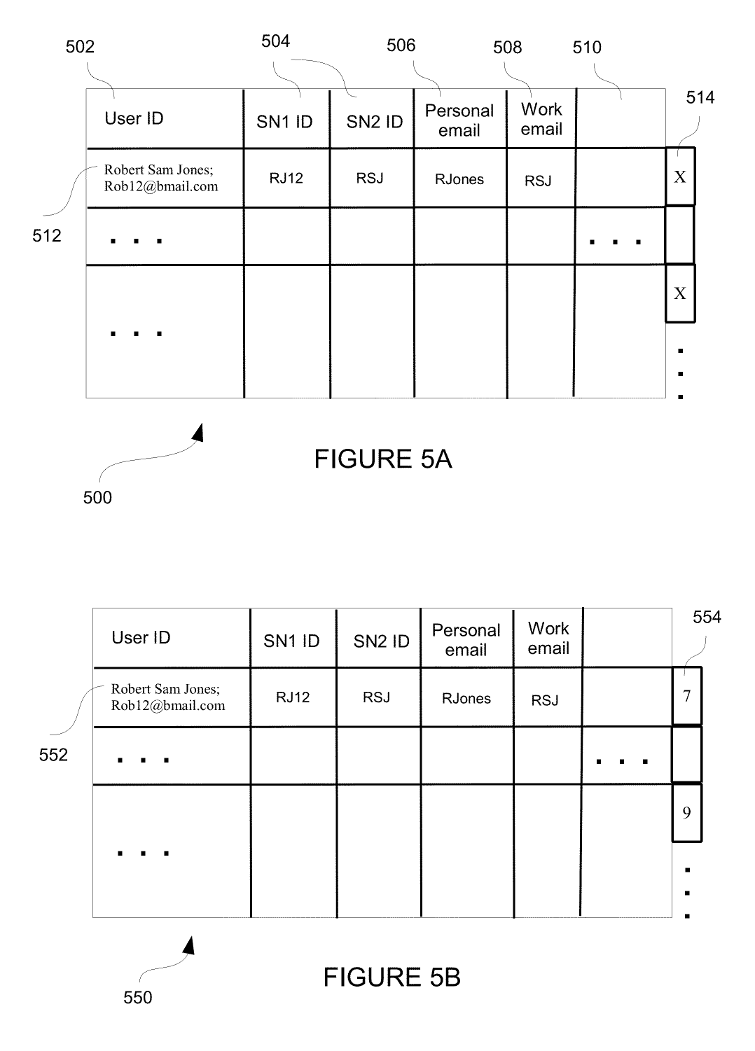

FIGS. 5A and 5B show example database records configured to store information associated with a remote user. With reference to FIG. 5A, in various embodiments, database table 500 includes database records 512, each record having different fields such as a unique user ID 502, social network IDs or usernames 504, personal emails' usernames 506, work emails usernames 508, other information fields 510, and validation field 514.

With reference to FIG. 4, once local user 1 validates a new username for a particular remote sender or user, the new username is added to the corresponding record for the particular remote sender and the validation field 514 is updated. In some embodiments, validation field 514 is associated with the entire record 512, while in other embodiments, each username field (for example, fields 504, 506, and 508) includes its own private validation field to indicate whether the particular username field has valid data or not.

With reference to FIG. 5B, in various embodiments, database table 550 includes database records 552, each record having different fields such as those enumerated with respect to FIG. 5A. In some embodiments, validation field 554 is based on a quantified value range indicating the confidence level in or degree of validity of the corresponding database record 552, instead of just signifying whether the record is valid or not. For example, the validation field may include a value between 1 to 10, with 10 being the highest confidence level in the corresponding data. Additionally, in some embodiments, validation field 554 is associated with the entire record 552, while in other embodiments, each username or data field includes its own private validation field to indicate the confidence level in the particular data field.

FIG. 6 shows an example email software application interface configured to allow delivery of unique identification of a remote user previously stored in a database. In various embodiments, communication environment 600 used by a local user, such as user 1, may include email application 602 having message display area 612, USC user interface 614, and user identification display area 616 for displaying the real identity 618 of a remote user. A remote user may send a message from a computing device through network 624 to user 1. Various usernames potentially associated with the remote user may be retrieved by USC user interface 614 from various external sources such as social networks 630 and Data Base Management System (DBMS) 626 having Data Base (DB) storage 628 for display to user 1.

In various embodiments, USC compares various usernames potentially associated with the remote user with existing records in the database to validate the usernames as belonging to the remote user. The valid names are displayed in user identification display area 616 along with the real identity of the remote user 618. Using the listed usernames, user 1 may send the same message or different messages to multiple usernames of the remote user at different organizations or services. For example, user 1 may send a party invitation to the remote user's Facebook page, his work email, and his personal email, each of which may have a different username for the remote user, being substantially certain that all of these usernames belong to the same person and the message is received by the same person at different electronic places in cyberspace. Those skilled in the art will appreciate that the processing, verification, validation, and comparison of the different usernames associated with the same remote user may be performed by the USC, DBMS 626, communication application such as email application 602, or a combination thereof.

In various embodiments, DBMS 626 may be a central database accessible by different users as an online public service. In other embodiments, DBMS 626 may be a local database, a peer-to-peer distributed database in which each set of records may be on a different physical computer, or a database within the network firewall of in an enterprise environment, such as large corporations or governments, for use by authorized members of the enterprise.

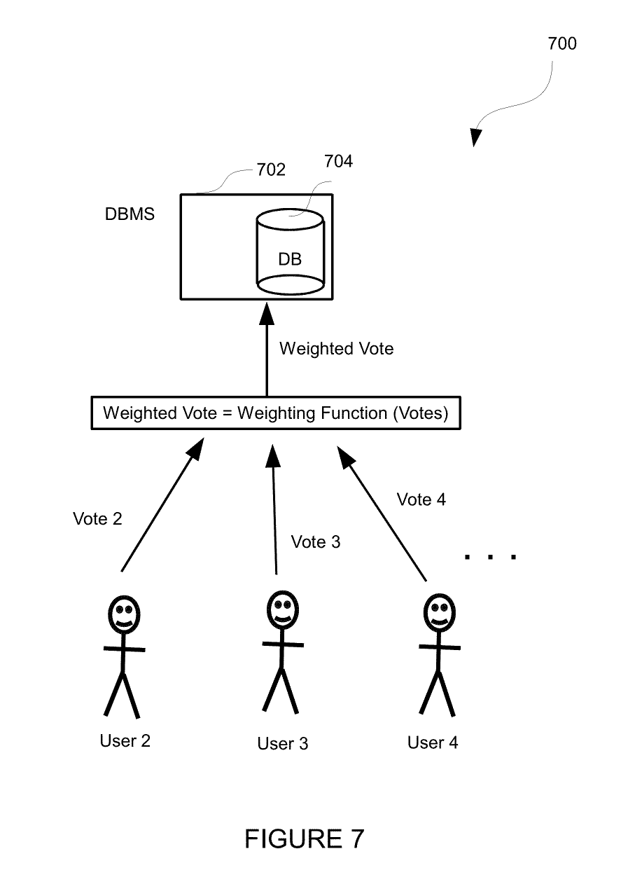

FIG. 7 shows an example weighted voting process by multiple remote users to establish a unique identity for another user. In various embodiments, data validation environment 700 includes DBMS 702 having database storage unit 704 configured to receive and/or process votes from multiple users regarding the validity of a username for a remote user/sender. DBMS 702 is used similarly to DBMS 326 and other database management systems described above with respect to FIGS. 3-6. In various embodiments, votes such as vote 2, vote 3, and vote 4 from individual users such as user 2, user 3, and user 4, respectively, are received by a vote processing application to be processed using a weighting function and generate a weighted vote, which at least partially defines the certainty or confidence level in a username database entry. In other embodiments, votes are simply counted, using a counter and use the final or highest count as the validation score for the data entry.

The weighting function may be any mathematical function suitable for this purpose. For example, the weighting function may be a linear combination of the form: “Weighted Vote=A * vote 2+B * vote 3+C * vote 4+ . . . ,” where A, B, C, . . . are numerical coefficients multiplied by given votes, and vote 2, vote 3, vote 4, . . . are numbers in some predefined range, such as 1 to 10, provided by the users. The coefficients may be assigned to various users/votes based on different factors, such as users' familiarity with the remote user, number of previous contacts between the voting users and the remote user, quality and success record of the voting users in voting for other remote users, and the like.

In various embodiments, database 704 is continuously updated based on votes from various users. Thus, database 704 provides a reliable source for various users to ascertain whether a given username belongs to a particular remote user/sender or not.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

1. A communication environment comprising:
a communication software application configured to provide messaging services between a remote user and a local user; and
a Username Software Component (USC) coupled with the communication software application and configured to search and retrieve a plurality of usernames associated with the remote user from external sources.

2. The communication environment of claim 1, further comprising a database configured to communicate with the USC and to store the usernames associated with the remote user.

3. The communication environment of claim 1, wherein the USC is a plug-in component deployed onto the communication software application.

4. The communication environment of claim 1, wherein the communication software application is an electronic mail (email) application.

5. The communication environment of claim 1, wherein the USC is further configured to validated the plurality of retrieved usernames.

6. The communication environment of claim 5, wherein the USC uses input from the local user to validate the plurality of retrieved usernames.

7. The communication environment of claim 5, wherein the USC uses a weighted vote function to validate the plurality retrieved usernames.

8. The communication environment of claim 1, wherein the USC is further configured to communicate with external social networks over a computer network.

9. The communication environment of claim 1, wherein the external sources include social networks and a central database.

10. A Username Software Component (USC) usable in a communication environment, the USC comprising:
a search module configured to search for usernames associated with a particular user of a communication environment; and
a validation module configured to validate usernames found by the search module as identifying the particular user.

11. The username software component of claim 10, further comprising a communication module configured to communicate with external data sources.

12. The username software component of claim 11, wherein the external data sources include social networks.

12. (canceled)

13. The username software component of claim 10, wherein the validation module validates usernames by using a weighting function to calculate a weighted vote from a plurality of user votes.

14. The username software component of claim 10, wherein the USC is a plug-in component.

15. The username software component of claim 10, wherein the communication environment includes an electronic mail (email) application.

16. A method of username validation in a communication environment, the method comprising:
receiving a message from a sender in the communication environment;
searching for other usernames associated with the sender using a first username associated with the sender; and
validating the other usernames as being associated with the sender.

17. The method of claim 16, further comprising storing the validated other usernames in a database.

18. The method of claim 16, wherein searching for other usernames comprises searching social networks.

19. The method of claim 16, wherein validating the other usernames comprises using input from a receiver of the message to validate the other usernames.

20. The method of claim 16, wherein validating the other usernames comprises using a weighting function to generate a weighted vote to validate the other usernames.

21. The username software component of claim 10, further comprising a database interface module for data transmission to and from a database.
